(19) United States
(12) Patent Application Publication
(10) Pub. No.: US 2009/0051633 A1
(43) Pub. Date: Feb. 26, 2009

(54) Electro-wetting display device field of the invention

(75) Inventors: Shuo-Ting Yan, Miao-Li (TW); Yu-Lin Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/229,640

(22) Filed: Aug. 25, 2008

(30) Foreign Application Priority Data
Aug. 24, 2007 (CN) 200710076560.5

(51) Int. Cl. G09G 3/34

(52) U.S. Cl. 345/84

(57) ABSTRACT

An exemplary electro-wetting display (EWD) includes a plurality of pixel regions, and each pixel region includes a first substrate; a second substrate opposite to the first substrate; a first conductive liquid disposed between the first and second substrates; a second, colored, non-conductive liquid disposed between the first and second substrates, and the second liquid being immiscible with the first liquid; and an electrode disposed at a surface of the second substrate adjacent to the first substrate. The electrode includes a cutout portion to define a containing space for receiving the second liquid while the pixel region displaying white. The electrode includes an edge corresponding to an edge of the cutout portion, and the edge of the electrode has a shape corresponding to a shape of an edge of the second liquid while being receiving in the containing space.

### FIELD OF THE INVENTION

The present invention relates to display devices, and more particularly to an electro-wetting display device having first and second immiscible fluid within a space between a first transparent support plate and a second support plate.

### GENERAL BACKGROUND

Display devices like TFT-LCDs (thin film transistor liquid crystal displays) are used in laptop computers, but also find an increasingly wider application in GSM telephones. Instead of LCDs, for example, (polymer) LED display devices are also being used. Apart from these types of displays, other display techniques, such as electro-wetting display (EWD) devices that are suitable for flat plate displays are evolving. The electro-wetting functionality provides displays with excellent brightness and contrast, and relatively low power consumption compared to many other display technologies.

In general, each of the pixel electrodes of the EWD device has a cutout portion, and each cutout portion defines a containing space for receiving the shielding liquid of the EWD device while the corresponding pixel displaying white. In general, the cutout portion has a rectangular shape. However, due to surface tension of the shielding liquid and the physics theory that the object being liable to retain at a stable state having a smallest energy, the shielding liquid is liable to retain at a shape that has a smallest surface area so as to maintain itself in a state having smallest surface energy. Moreover, according to geometry theory, sphere has a smallest surface area while the volume is invariable. Thus, the shielding liquid is liable to be in a spherical shape while being received in the containing space, which is not like the rectangular shape of the cutout portion. Therefore, the rectangular cutout portion cannot contain the shielding liquid stably.

It is, therefore, needed to provide an EWD device that can overcome the above-described deficiencies.

### SUMMARY

An EWD device includes a plurality of pixel regions, and each pixel region includes a first substrate; a second substrate opposite to the first substrate; a first conductive liquid disposed between the first and second substrates; a second, colored, non-conductive liquid disposed between the first and second substrates, and the second liquid being immiscible with the first liquid; and an electrode disposed at a surface of the second substrate adjacent to the first substrate. The electrode includes a cutout portion to define a containing space for receiving the second liquid while the pixel region displaying white. The electrode includes an edge corresponding to an edge of the cutout portion, and the edge of the electrode has a shape corresponding to a shape of an edge of the second liquid while being receiving in the containing space.

Other novel features and advantages will become more apparent from the following detailed description when taken in conjunction with the accompanying drawings, in which:

### BRIEF DESCRIPTION OF THE DRAWINGS

FIG. 1 is a side, cross-sectional view of parts of a pixel region of an EWD device according to a first embodiment of the present invention.

FIG. 2 is a top, plan view of the pixel region of the EWD device of FIG. 1.

FIG. 3 is a top, plan view of a pixel region of an EWD device according to a second embodiment of the present invention.

FIG. 4 is a top, plan view of a pixel region of an EWD device according to a third embodiment of the present invention.

FIG. 5 is a top, plan view of a pixel region of an EWD device according to a fourth embodiment of the present invention.

FIG. 6 is a top, plan view of a pixel region of an EWD device according to a fifth embodiment of the present invention.

### DETAILED DESCRIPTION OF PREFERRED EMBODIMENTS

Reference will now be made to the drawings to describe preferred and exemplary embodiments of the present invention in detail.

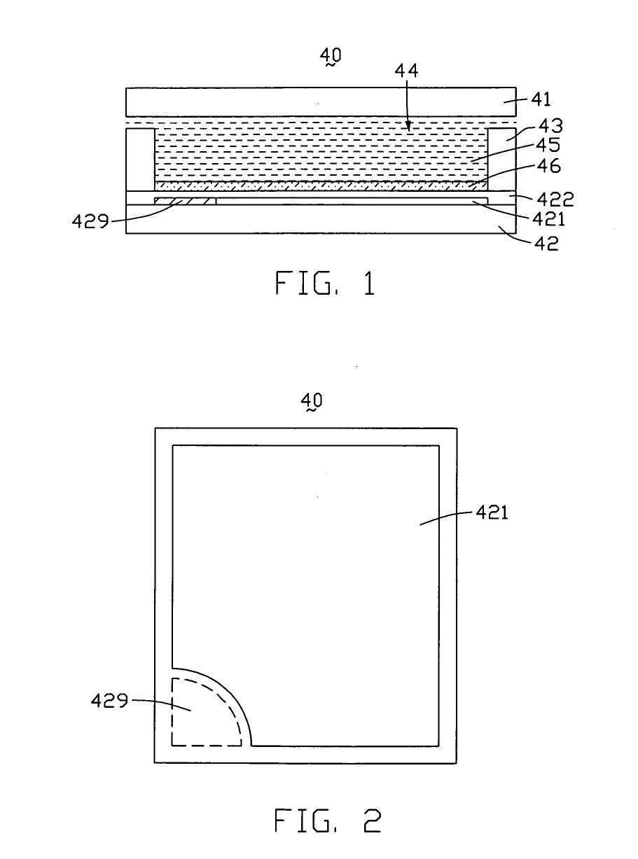

Referring to FIG. 1, a side, cross-sectional view of parts of a pixel region 40 of an EWD device according to a first embodiment of the present invention is shown. The pixel region 4 includes a first substrate 41, a second substrate 42 disposed parallel to and spaced apart from the first substrate 41, and a plurality of side walls 43 interposed between the first and second substrates 41, 42. The side walls 43 are arranged in a matrix and cooperate with the first and second substrates 41, 42 to form a plurality of receiving spaces 44. The side walls 43 also divide the EWD device 4 into a multiplicity of pixel units 40 in an array type. The first substrate 41 is made of transparent material, such as glass, plastic or the like.

The space 44 of the pixel unit 40 is filled with a first liquid 45 and a second liquid 46. The first liquid 45 is polar, conductive water solution or salt solution, such as a solution mixed with Ethyl Alcohol and potassium chloride solution. The second liquid 46 is non-polar, insulative liquid, such as oil, Alkane, Hexadecane or the like. The second liquid 46 can be colored with a dye (or in some cases pigment), and serves as a shielding liquid. The first and second liquid 45, 46 are immiscible.

The second substrate 42 includes an electrode 421 and an insulating layer 422 disposed at an upper surface of the second substrate 42 adjacent to the first substrate 41. The electrode 421 is disposed on the second substrate 42, and the insulating layer 422 is disposed on the electrode 421 and throughout the pixel region 40. The insulating layer 422 may be made of hydrophobic material, such as an amorphous fluoropolymer.

Also referring to FIG. 2, a top, plan view of the pixel unit 40 is shown. The electrode 421 includes a fan-shaped cutout portion 429 disposed at a corner portion of the electrode 421, which serves as a containing space for receiving the second liquid 46 while being pushed by the first liquid 45. The fan-shaped cutout portion 429 is substantially a quarter circle, which has a centre disposed at a bottom angle of the pixel region 40 and two sides along sides of the pixel region 40. That is, an edge of the electrode 421 corresponding to an edge of the cutout portion 429 is an arc of a quarter circle, which has a centre of the quarter circle is disposed at a bottom angle of the pixel region 40.

When the pixel region 40 displays a black image (in an off state), a voltage applied to the first liquid 45 is the same as a voltage applied to the electrode 421, and there is no Coulomb force generating between the first liquid 45 and the electrode 421. The hydrophobic insulating layer 422 is made of hydrophobic material, and then the second liquid 46 are liable to push the first liquid 45 aside, so as to thoroughly cover the surface of the insulating layer 422. Thus, the first liquid 45 is disposed between the first substrate 41 and the second liquid 46. Due to the second liquid 46 serves as a shielding liquid, the pixel region 40 displays a black image.

When the pixel region 40 displays a white image (in an on state), voltage difference is generated between the first liquid 45 and the electrode 421, so as to make the first liquid 45 and the electrode 421 generate reverse electric charge. Then, the first liquid 45 push the second liquid 46 to the cutout portion 429 due to attract by the Coulomb force generating between the first liquid 45 and the electrode 421. Therefore, the pixel region 40 display white image.

When the second liquid 46 is contained in the cutout portion 429, an edge of the second liquid 46 adjacent to the electrode 421 is liable to maintain at an arc shape naturally due to without blocking by the side wall 43. The electrode 421 includes an edge corresponding to the edge of the cutout portion 429, and the edge of the electrode 421 has a shape corresponding to a shape of the edge of the second liquid 46 while the second liquid 46 being received in the containing space. Therefore, the electrode 421 can provide an electric field to stably maintain the second liquid 46 in the cutout portion 429.

Compared with the conventional EWD device, the electrode 421 includes a fan-shaped cutout portion 429 disposed at a corner of the pixel region 40, and the edge of the electrode 421 corresponding to the cutout portion 429 has an arc shape, which is corresponding to the shape of the edge of the second liquid 46 while being received in the containing space. Then, the second liquid 46 is stably maintained in the containing space.

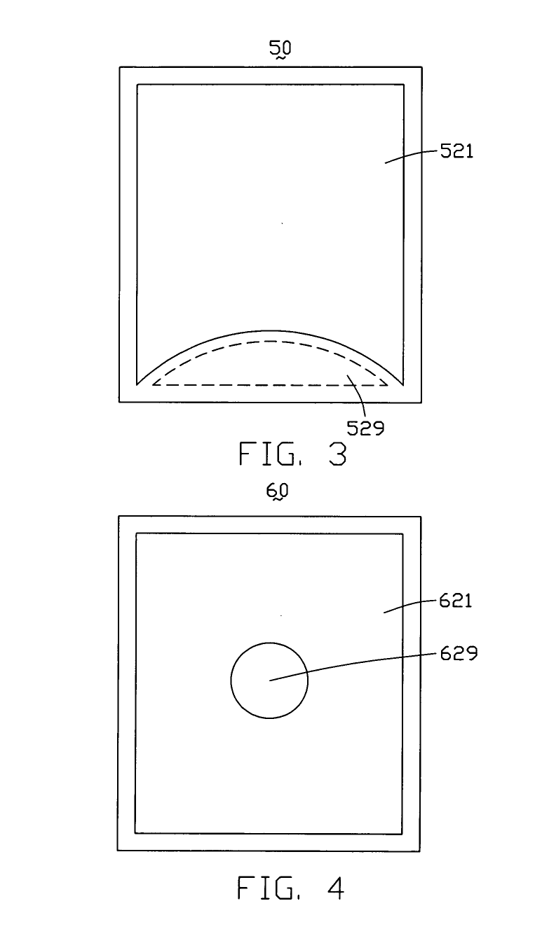

Referring to FIG. 3, a top, plan view of a pixel region of an EWD device according to a second embodiment of the present invention. This EWD device has a structure similar to that of the EWD device of the first embodiment. However, in the pixel region 50, the electrode 521 has a cutout portion 529 disposed at a side of the pixel region 50. An edge of the electrode 521 corresponding to the cutout portion 529 is curved toward the electrode 521.

Referring to FIG. 4, a top, plan view of a pixel region of an EWD device according to a third embodiment of the present invention. This EWD device has a structure similar to that of the EWD device of the first embodiment. However, in the pixel region 60, the electrode 621 has a circle cutout portion 629 disposed at a central portion of the pixel region 60. An edge of the electrode 621 corresponding to the cutout portion 629 is circular.

Various modifications and alterations are possible within the ambit of the invention herein. For example, the edges of the electrodes 421, 521,621 corresponding to the cutout portions 429, 529, 629 may be a differentiable curve. That is, the edges may be smooth curves.

Referring to FIG. 5, a top, plan view of a pixel region of an EWD device according to a fourth embodiment of the present invention. This EWD device has a structure similar to that of the EWD device of the first embodiment. However, in the pixel region 70, the electrode 721 has a circle cutout portion 729 disposed at a corner portion of the pixel region 70. An edge of the electrode 721 corresponding to the cutout portion 729 is a piecewise differentiable curve, which includes a plurality of smooth segment curves connected one by one.

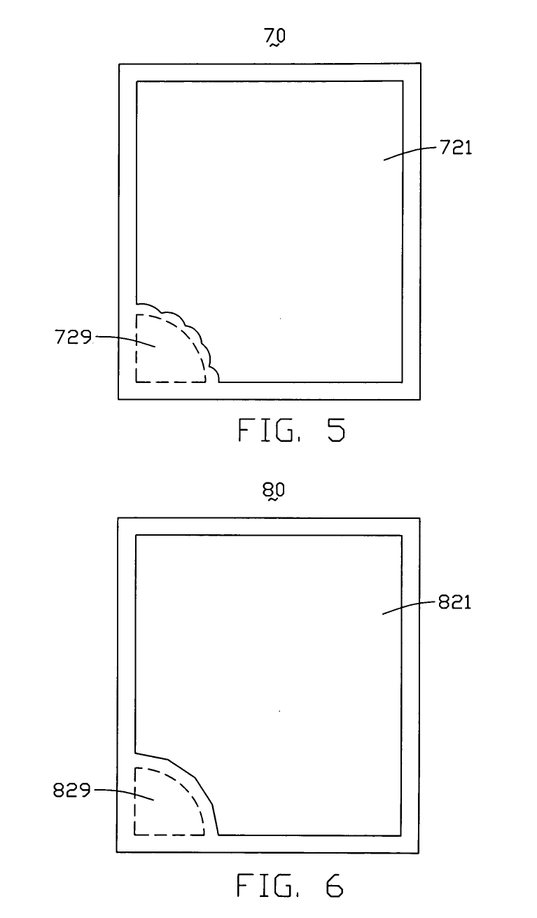

Referring to FIG. 6, a top, plan view of a pixel region of an EWD device according to a fifth embodiment of the present invention. This EWD device has a structure similar to that of the EWD device of the first embodiment. However, in the pixel region 80, the electrode 821 has a circle cutout portion 829 disposed at a corner portion of the pixel region 80. An edge of the electrode 821 corresponding to the cutout portion 829 is a curve having a plurality of bent portions, and an angle between each two bent portions is an obtuse angle.

It is to be further understood that even though numerous characteristics and advantages of preferred and exemplary embodiments have been set out in the foregoing description, together with details of structures and functions associated with the embodiments, the disclosure is illustrative only, and changes may be made in detail (including in matters of arrangement of parts) within the principles of the invention to the full extent indicated by the broad general meaning of the terms in which the appended claims are expressed.

What is claimed is:

1. An electro-wetting display device, comprising:
a plurality of pixel regions, each pixel region comprising:
a first substrate;
a second substrate opposite to the first substrate;
a first conductive liquid disposed between the first and second substrates;
a second, colored, non-conductive liquid disposed between the first and second substrates, and the second liquid being immiscible with the first liquid; and
an electrode disposed at a surface of the second substrate adjacent to the first substrate;
wherein the electrode comprises a cutout portion to define a containing space for receiving the second liquid while the pixel region displaying white, the electrode comprises an edge corresponding to an edge of the cutout portion, and the edge of the electrode has a shape corresponding to a shape of an edge of the second liquid while being received in the containing space.

2. The electro-wetting display device as claimed in claim 1, wherein the edge of the electrode is arcuate.

3. The electro-wetting display device as claimed in claim 1, wherein the edge of the electrode is curved.

4. The electro-wetting display device as claimed in claim 3, wherein a centre of the curved edge of the electrode is at a side of the cutout portion.

5. The electro-wetting display device as claimed in claim 3, wherein the edge of the electrode is a differentiable curve.

6. The electro-wetting display device as claimed in claim 3, wherein the edge of the electrode is a piecewise differentiable curve.

7. The electro-wetting display device as claimed in claim 3, wherein the cutout portion is disposed at a corner of the pixel region.

8. The electro-wetting display device as claimed in claim 3, wherein the cutout portion is disposed at a side of the pixel region.

9. The electro-wetting display device as claimed in claim 3, wherein the cutout portion is disposed at a central portion of the pixel region.

10. The electro-wetting display device as claimed in claim 1, wherein the edge of the electrode is a curve comprising a plurality of bent portions connected one by one, and an angle between each two bent portions is an obtuse angle.

11. An electro-wetting display device, comprising:
a plurality of pixel regions, each pixel region comprising:
a first substrate;
a second substrate opposite to the first substrate;
a first conductive liquid disposed between the first and second substrates;
a second, colored, non-conductive liquid disposed between the first and second substrates, and the second liquid being immiscible with the first liquid; and
an electrode disposed at a surface of the second substrate adjacent to the first substrate;
wherein the electrode comprises a cutout portion at a corner thereof to define a containing space for receiving the second liquid while the pixel region displaying white, the electrode comprises a contour section facing said cutout, and contour section defines a roughly curved extension partially surrounding said cutout.
